(19) United States
(12) Patent Application Publication
(10) Pub. No.: US 2009/0316518 A1
(43) Pub. Date: Dec. 24, 2009

(54) VERTICAL MIXING TANK

(76) Inventor: Kenneth D. Goldsmith, Midland, TX (US)

Correspondence Address: Law;Firm, 500 West Illinois, Ste 685, Midland, TX, 79701, US

(21) Appl. No.: 12/490,294

(22) Filed: Jun. 23, 2009

Related U.S. Application Data
(60) Provisional application No. 61/062,134, filed on Jun. 23, 2008.

(51) Int. Cl. B01F 15/02

(52) U.S. Cl. 366/134

(57) ABSTRACT

A vertical mixing tank for storage and mixing of fluids, comprising a tank having cylindrical walls, a conical bottom, and a semi-closed top; a plurality of mixing educators disposed internally to the tank; a centrifugal pump connected to the conical bottom; a set of educator pipes operably connected to the centrifugal pump to provide fluid from the centrifugal pump to the plurality of mixing educators.

### CROSS-REFERENCE TO RELATED APPLICATIONS

This Application claims priority to pending Provisional U.S. Application Ser. No. 61/062,134, filed on Jun 23, 2008.

### TECHNICAL FIELD

The system of the innovations described herein relate generally to tank system for mixing, storing and suspending solid-laden slurries. More specifically, the system relates to a tank system used in drilling, completion and work-over of water, oil/gas or geothermal wells.

### BACKGROUND

Drilling fluids known as drilling mud, or just simply mud, are traditionally mixed and stored in horizontal tanks. A commonly used mud system for drilling uses inexpensive additives to build up huge volumes of mud in horizontal circulating pits to provide for losses of large volumes of this inexpensive mud into thief zones without shutting down drilling, or resulting in high mud costs. Due to the inefficient agitation & circulation of horizontal pits, hundreds, or often thousands of barrels of mud are wasted on each well drilled. Historically, operators have turned a blind eye to the waste related costs & the environmental impact of the commonly used mud systems. Mud costs typically represent ˜2% or less of the total drilling cost of a new well, so its cost is often marginalized in the process.

The U.S. Pat. No. 5,944,418, titled “Tank Storage and Agitation System” invented by Alan Orr et al and issued on Aug. 31, 1999 drawback is that it contains baffles and impeller blades to mix the fluids in the tank, which are expendable and tend to break, as well as requiring people to enter the tank for cleaning and maintenance. What is needed is a vertical tank system that eliminates sediment of solids in dead corners or flat surfaces and eliminates the need for moving expendable parts inside the vessel.

### SUMMARY

To achieve the foregoing, and in accordance with the purpose of the presently preferred embodiment as broadly described herein, the present application provides a vertical mixing tank for storage and mixing of fluids, comprising a tank having cylindrical walls, a conical bottom, and a semi-closed top; a plurality of mixing eductors disposed internally to the tank; a centrifugal pump connected to the conical bottom; a set of eductor pipes operably connected to the centrifugal pump to convey fluid from the centrifugal pump to the plurality of mixing eductors.

Other advantages of the presently preferred embodiment will be set forth in part in the description and in the drawings that follow, and, in part will be learned by practice of the presently preferred embodiment. The presently preferred embodiment will now be described with reference made to the following Figures that form a part hereof. It is understood that other embodiments may be utilized and changes may be made without departing from the scope of the presently preferred embodiment.

### BRIEF DESCRIPTION OF THE DRAWINGS

A presently preferred embodiment will hereinafter be described in conjunction with the appended drawings, wherein like designations denote like elements, and:

FIG. 1 is a side-view illustration of a vertical mixing tank system; and

FIG. 2 is a close-up cut out illustration of vertical mixing tank system.

### DETAILED DESCRIPTION

The embodiments discussed herein are merely illustrative of specific manners in which to make and use the invention and are not to be interpreted as limiting the scope. While the embodiment is described with a certain degree of particularity, it is to be noted that many modifications may be made in the details of the embodiment's construction and arrangement of its components without departing from the spirit and scope of this disclosure. It is understood that the embodiment is not limited to those set forth herein for purposes of exemplifications.

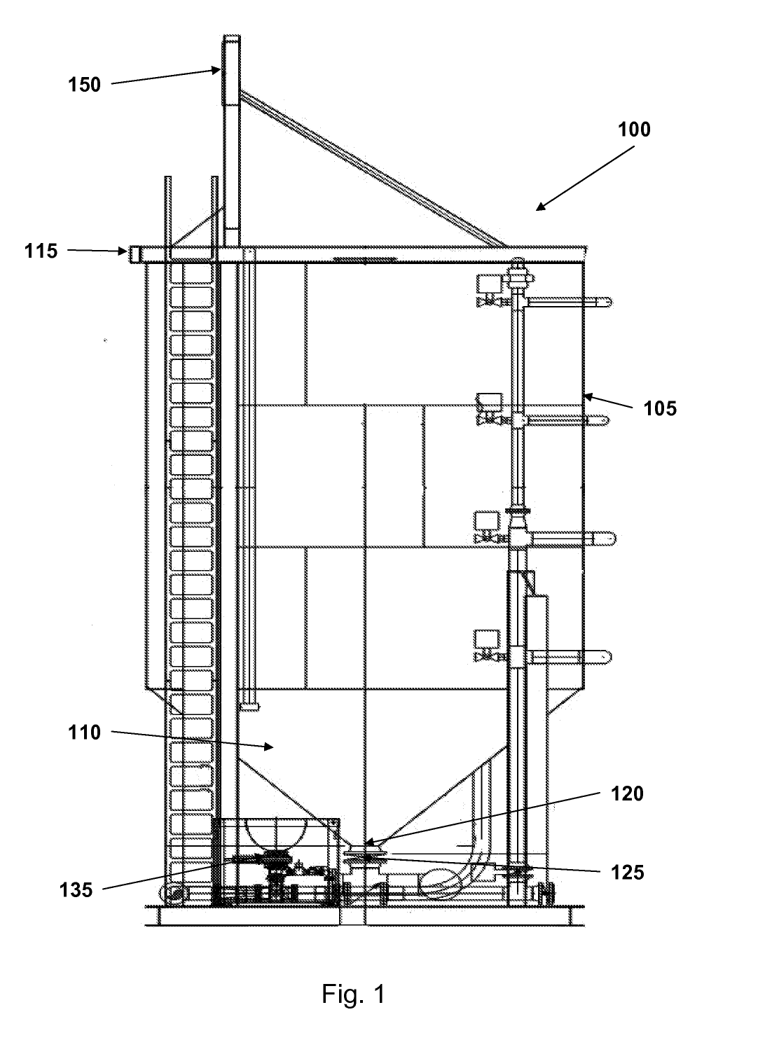

FIG. 1 is a side-view illustration of a vertical mixing tank system. Referring further to FIG. 1, the embodiment is a tank 100 having a cylindrical wall 105, a conical bottom 110, and a semi-closed top 115. The cylindrical wall 105 begins with the semi-closed top 115 and ends by tapering to the conical bottom 110, where the conical bottom 110 is preferably at a 45 degree angle. At the tip of the conical bottom 110 is an opening 120 with a flange that is connected to a centrifugal pump 125. The flange connection of the centrifugal pump 125 to the conical bottom 110 preferably reduces cavitations. The centrifugal pump 125 is powered by a motor 130 that is preferably electrical, but may be diesel or some other alternative. It is also foreseeable that a programmable logic controller (PLC) is able to control the motor 130 as well as the centrifugal pump 125 in known manners well understood in the art. The tank 100 preferably mixes and stores slurries containing both liquids and solids. The slurries exit the tank 100 through the centrifugal pump 125 for discharge along discharge pipes in either direction to, for example, mud pits, trucks and mud storage tanks, where it is well understood in the art what drilling fluid “mud” is.

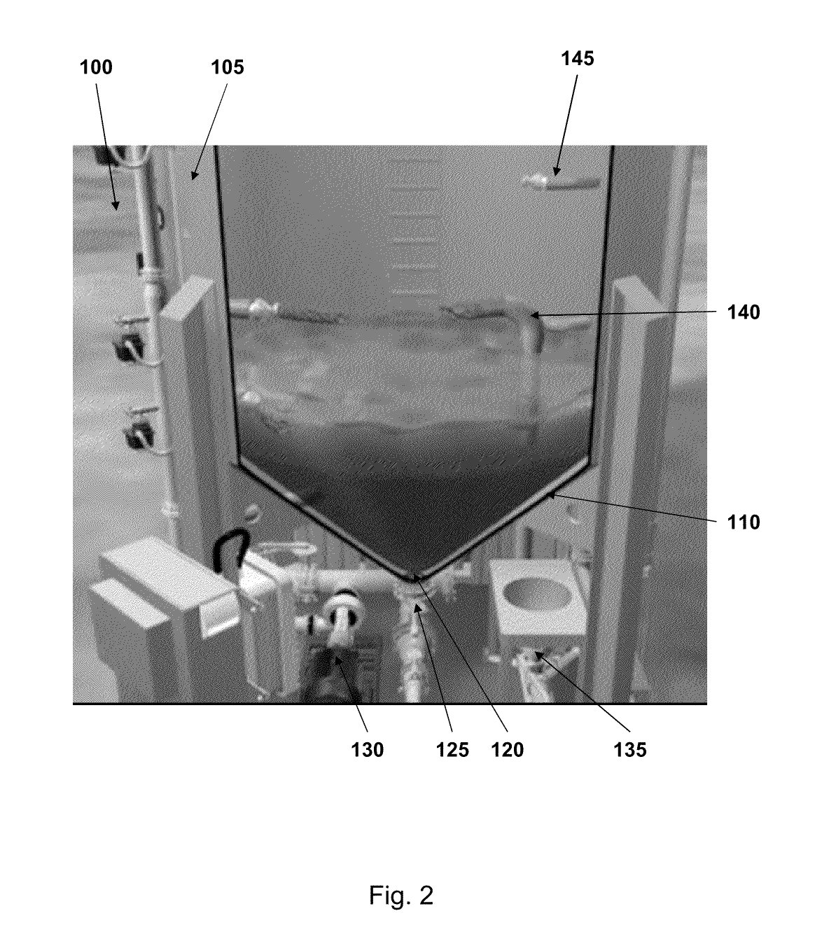

FIG. 2 is a close-up cut out illustration of vertical mixing tank system. Referring further to FIG. 2, slurries can exit the tank 100 and act like motive fluid for a venturi mixing hopper 135. The venturi mixing hopper 135 allows the mixing of bagged, dry bulk, or liquid additives in a dust free environment. The venturi mixing hopper 135 discharges horizontally into the tank 100 through a hopper discharge pipe 140 to provide agitation to the slurry.

Continuing, the centrifugal pump sends the slurry to eight (8) mixing eductors 145, where the mixing educators 145 are preferably controlled by not only the PLC or manually, but also a guided wave electronic fluid level indicator that aids in the determination of which mixing eductor 145 should be active based upon the level of slurry in the tank 100. Further, the mixing eductors 145 are disposed in pairs opposite from one another, and alternating from right angle to obtuse to right angle and finally to obtuse, for example, on 90 degree and 45 degree angles. The position of the mixing eductors 145 preferable face one another so that the slurry discharge spins the slurry in the counter-clockwise direction, although the mixing eductors 140 can be orientated to cause the slurry to mix in a clockwise direction. It is anticipated that the PLC in conjunction with the guided wave electronic fluid level indicator can regulate the amount of fluid flowing through the mixing eductors 145, for example, in a specific sequence or all at once. Regardless of how the mixing eductors 145 control the flow of fluid, the intent is that the slurry solution is properly mixed and agitated in a vortex manner.

It is further contemplated that the tank is mounted on a vertical load support system 150 that includes a plurality of I-beam uprights or square tubing attached to the exterior of the cylindrical wall with a base of each of an upright connected to a skid structure. The tank along with the uprights and skid structure is equipped with a kingpin hitch, a set of rear axles, and a set of pneumatic tires to reduce the need for trailering the tank unit when in transit.

Whereas the embodiment has been described in relation to the drawings attached hereto, it should be understood that other and further modifications, apart from those shown or suggested herein, may be made within the spirit and scope of this embodiment.

1. A vertical mixing tank for storage and mixing of fluids, comprising:
a tank having cylindrical walls, a conical bottom, and a semi-closed top;
a plurality of mixing eductors disposed internally to the tank;
a centrifugal pump connected to the conical bottom;
a set of pipes operably connected to the centrifugal pump to provide fluid from the centrifugal pump to the plurality of mixing eductors.

2. The vertical mixing tank of claim 1, further comprising a plurality of hopper discharge pipes disposed internally to the tank.

3. The vertical mixing tank of claim 2, wherein the centrifugal pump provides motive fluid for a venturi mixing hopper to provide a mixture to the plurality of hopper discharge pipes.

4. The vertical mixing tank of claim 1, wherein the plurality of mixing eductors are radially disposed in opposing pairs.

5. The vertical mixing tank of claim 4, wherein the flow of fluid through in the mixing eductors into the tank occurs in a clockwise direction.

6. The vertical mixing of claim 4, wherein the flow of fluid through in the mixing eductors into the tank occurs in a counter-clockwise direction.
